(19) United States
(12) Patent Application Publication
(10) Pub. No.: US 2008/0057916 A1
(43) Pub. Date: Mar. 6, 2008

(54) REAL-TIME, INTERACTIVE BALANCE CHECK FOR WIRELESS SERVICE

(76) Inventors: James Gamm, Walnut Creek, CA (US); John Bamforth, Antioch, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/468,213

(22) Filed: Aug. 29, 2006

(51) Int. Cl. H04Q 7/38

(52) U.S. Cl. 455/414.1

(57) ABSTRACT

Subscribers of a wireless communication services network can check their account balances in a real-time interactive environment. A subscriber requests balance information for the subscriber's account using a mobile wireless device. The request may be made using a single-key interface on the subscriber's wireless device. In response to the request, a billing system queries a subscriber database and obtains the subscriber's account balance. The balance information is then returned to the subscriber as a page of information, such as a WAP page. The billing system may implement a feature that charges subscribers for checking their balances if certain criteria are met.

### BACKGROUND

1. Field of the Invention

This invention relates generally to wireless communication services, such as pre-paid cellular services, and more particularly to checking an account balance for a wireless communication service.

2. Background of the Invention

Wireless communication services, such as cellular-based telephone and data services, are traditionally paid for after the service is provided. In a typical service, a wireless subscriber receives a monthly statement through the mail of the charges incurred from the previous month. The charges for a particular month are usually determined according to the subscriber's usage of the system and a pre-selected service plan. The subscriber then pays each monthly bill by returning a check through the mail or by credit or electronic debiting of the subscriber's account.

While this billing scheme is satisfactory for some users, it has a number of features that many users find undesirable. Because it forces subscribers to lock in to a particular service plan, the scheme does not meet the needs of subscribers whose varying usage may benefit from more flexibility. It also enables subscribers to incur large bills at the end of a particular month, which may be unacceptable for users with poor credit or those for whom the service is paid by a third party. Parents, for example, might want to limit or monitor the wireless fees incurred by their children over the course of a month.

Pre-paid wireless services have thus emerged to address many of the shortcomings of the traditional monthly wireless service plans. Under a typical pre-paid payment scheme, subscribers place an amount of money or other service credits into their wireless accounts before using the service. When a subscriber uses the service, the subscriber's account is debited based on the subscriber's usage and a particular service plan or other pricing system. The use of the service may include voice calls, data transfers (such as text or multimedia messages or network access), purchases of content (such as games, ring tones, or any other media), or any of a wide variety of services and/or products available for purchase through the wireless service. The subscriber can use the wireless service as desired until the subscriber's account no longer contains sufficient funds for a particular requested service. At any time, such as when the account needs additional funds for a requested service, a subscriber may add funds or other credits to the subscriber's account. Any of a number of mechanisms may be used for adding value to the subscriber's account, such an interface through the subscriber's mobile device, an Internet web page, a retail environment, or any other appropriate mechanism for this type of transaction. By pre-paying and then adding to their accounts as desired, the subscribers can better manage and control their usage of the wireless services.

One tool for managing a subscriber's account is monitoring the account balance over time. Without knowing how much value is left in their pre-paid accounts, subscribers will not know when to add value to their accounts or how much value to add. Accordingly, a pre-paid account subscriber will ordinarily want to have real-time information of the account balance upon which make payment and usage decisions. Even subscriber's of traditional (i.e., non-pre-paid) accounts may want an accurate idea of the charges they have accrued in their account.

Unfortunately, existing methods for accessing an account balance have proven inadequate to meet the needs of the subscriber. For example, a subscriber may access an account balance via the Internet by accessing a web page for the service provider. But this method requires a computer and a web browser, so it does not allow access of balance information when the subscriber is at a remote location. A subscriber is likely to want balance information when and where the subscriber is using the wireless service. Therefore, it is desirable to allow access of the balance information from the subscriber's mobile device.

Other methods of accessing balance information have been enabled from the mobile device, but these, too, are inadequate. For example, subscribers have been able to request balance information from the service provider using their mobile devices. The balance information is then provided in a response message, such as a text or voice message delivered to a mobile phone. These messages may not be delivered right away, however, so they might not reflect the real-time balance information of the subscriber's account. Moreover, because the balance information is provided in a different format than the request for the balance information, the user experience is diminished. It is typically desirable for a user interface to respond to a request in the same environment the request is made.

Some mobile devices have counters to track the subscriber's usage, such as minutes of calling time and cumulative size of data transfers. But counters are wholly inadequate for providing balance information because they do not keep track of a pre-paid amount and they fail to accommodate variable pricing schemes. Counters also fail to track other types of purchases a subscriber may make, such as downloading games and ring tones.

Accordingly, there exists a need for a mechanism that allows subscribers of wireless services to check their balance information, such as a real-time value of a pre-paid wireless account, without the limitations of existing systems described above.

### SUMMARY OF THE INVENTION

A wireless service provider enables subscribers to access their account balances through a two-way communication mechanism between the wireless service and the subscribers' wireless devices. For example, a subscriber may request balance information for the subscriber's account using a mobile wireless device. In response to receiving the request, a billing system operated by the service provider queries a subscriber database and obtains the subscriber's account balance. The balance information is then returned to the subscriber as a page of information, viewable by the wireless device. In this way, the subscribers can check their account balances in a real-time, interactive environment, rather than having to wait to receive an SMS message in their inbox. One application of this balance checking method may be for pre-paid wireless service, for which real-time balance information is particularly important to subscribers.

In one embodiment, the balance checking system uses a markup language to communicate the balance information to the mobile device. For example, the markup language may be the Wireless Markup Language (WML) used in the Wireless Application Protocol (WAP). The balance information is encoded in the markup language in a page of information, which is then provided to the subscriber. The page of information is viewed on the subscriber's wireless device, for example, by a browser configured to interpret the page and render its contents on a display of the device.

In addition to providing a useful mechanism for subscribers to check their account balances, certain embodiments of the invention provide revenue generation opportunities for the service provider. For example, to offset the data costs associated with providing balance information, the service provider may charge subscribers for accessing their balance information. The service provider may set up any pricing scheme desired, such as charging subscribers for each balance retrieval over a predetermined limit in a given time period. In addition to generating revenue for the service provider, the pricing scheme may be designed to discourage overuse and/or abuse of the data system.

In other embodiments of the invention, the subscriber's wireless device includes a user interface that facilitates the balance checking features described herein. For example, the user interface may allow the subscriber to call up the page on which the balance information is provided by using a single keystroke on the device. The ease of accessing the balance information further promotes the usefulness of the feature—as well as its revenue-generating capability in certain embodiments. The user interface may also encourage the subscriber to add value to a pre-paid account. For example, the page that includes the subscriber's balance information may also include a link for adding value to the account. Advantageously, this facilitates purchase of the wireless services at a time when subscribers are most likely to be thinking about the need to add value to their accounts.

These and other features, aspects, and advantages of various embodiments of the invention will become better understood with regard to the following description and accompanying drawings.

### BRIEF DESCRIPTION OF THE DRAWINGS

FIG. 1 is a schematic diagram of a wireless services system, in accordance with an embodiment of the invention.

FIG. 2 is a trace diagram of a process for providing balance information to a subscriber's mobile device, in accordance with an embodiment of the invention.

FIG. 3 is a flow diagram of a user interface on a mobile device for requesting and receiving balance information, in accordance with an embodiment of the invention.

FIG. 4 is a flow diagram of a process for servicing a request for balance information for a mobile device, in accordance with an embodiment of the invention.

### DETAILED DESCRIPTION OF THE PREFERRED EMBODIMENTS

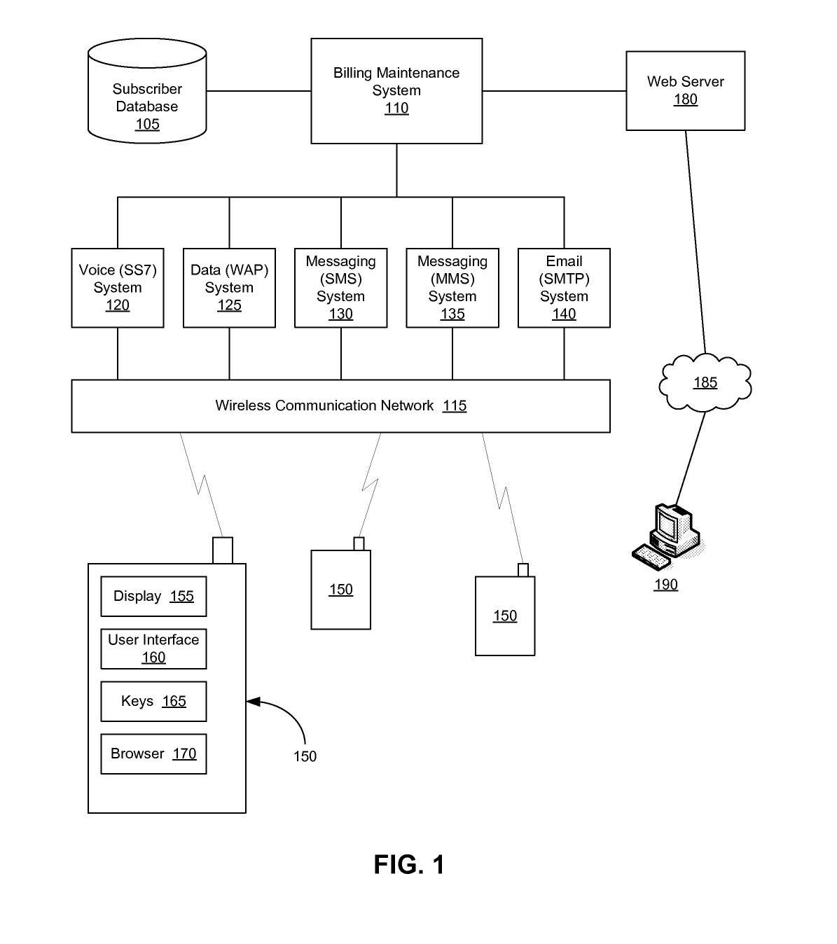

The balance checking functionality described herein may be applied to many different types of wireless services, each of which may be implemented using a variety of hardware and software architectures. FIG. 1 shows one example of a wireless services system; however, embodiments of the invention are not limited to this particular architecture or combination of wireless services shown, but rather they can be applied in many other environments.

In a basic scenario, subscribers use their wireless mobile devices 150 to communicate with the services system via a wireless communications network 115. The wireless services system shown in FIG. 1 includes a number of subsystems that provide services for the subscribers. In this example, the subsystems include a voice system 120 to allow subscribers to make voice calls via the wireless network 115 and a data system 125 to allow subscribers to access digital information over the network 115 from their wireless devices 150. The wireless services system may further include subsystems such as a text messaging system 130, multimedia messaging system 135, and an email system 140, enabling subscribers to send various types of asynchronous messages over the network 115. These and other types of wireless services are well known.

The wireless service provider may track the subscribers' use of the services using a billing maintenance system 110. The billing maintenance system 110 typically comprises a computer system having software for managing the subscriber accounts for the wireless service. The billing maintenance system 110 is coupled to a subscriber database 105, which stores entries for the subscribers' accounts. In one illustrative example, the data associated with a subscriber's account includes a unique identification number (such as the phone number for the wireless device), a status for the subscriber's account (e.g., current, past due, suspended, or expired), an access code for validation of the subscriber, an account balance, and an optional expiration date of the account (defined below).

The billing maintenance system 110 is communicatively coupled to the services subsystems 120 through 140 to monitor their usage. In this way, the billing maintenance system 110 can record the transaction data for each subscriber in the subscriber database 105. The transaction data is an account of each subscriber's use of the services, which may for example include the minutes and other details of voice calls, the amount of data sent and/or received in messages and emails, and the purchases of games or ring tones. As subscriber usage activity occurs, or periodically at other times, the billing maintenance system 110 adjusts the subscribers' account balances in the subscriber database 105 to debit the accounts for that usage as appropriate. The billing maintenance system 110 preferably also logs the usage activity in the subscriber database 105 so it can be later reported, for example, for billing or accounting purposes.

As shown in FIG. 1, the wireless devices 150 operated by the subscribers are configured to communicate wirelessly with the wireless communications network 115. Many types of wireless devices 150 exist, and other types will likely be developed in the future, but the devices 150 may comprise any products capable of communicating with the wireless network 115 described herein. This includes cellular phones, PDAs, handheld email devices, and similar devices.

In a typical embodiment, the wireless communication device 150 comprises a display 155, a user interface 160 for causing the display 155 to show content to a subscriber, and keys 165 to allow a subscriber to input controls and information. The keys 165 may include a first group of keys in the form of hard-coded keys (such as alphanumeric keys) and a second group of keys in the form of operation keys or “soft keys.” In one embodiment, the wireless device 150 further includes a browser 170 (such as a WAP browser or “minibrowser”) for viewing digital content encoded in a markup language.

The wireless service may be offered as a pre-paid service, in which subscribers add value to their accounts before using the network. In one example of a pre-paid service, the billing maintenance system 110 maintains the balance information for each of the subscribers, where the balance information includes an amount of value remaining in each subscriber's account. Based on pricing schemes defined by the service provider, a subscriber's usage of the network and/or other purchases associated with the subscriber's account causes a corresponding debiting of that account. The subscriber can continue to use the services while there is sufficient value in the account, after which the subscriber must add value to the account (also known as “topping up”). A variety of different payment methods may be used to replenish a pre-paid account including, without limitation, credit or debit card payments, direct payment from a checking account, and purchase and use of a PIN. Further, an expiration date may be set for each subscriber account, after which the account becomes inactive unless the subscriber adds value to the account. This date is typically set to be several months after the last time value was added to the account, or alternatively, after the last activity charged to the account.

In the context of the wireless services system shown in FIG. 1, and in particular in the context of pre-paid services, subscribers of the services may occasionally desire to see their balance information. The balance information typically includes an amount—usually in monetary terms—that remains in the account (in a pre-paid service) or that is owed for past usage (in a traditional end-of-month billing service). In accordance with embodiments of the invention, a subscriber may request and receive an account balance using a wireless device 150 according to any of the processes described below. Notwithstanding the wireless balance checking capabilities of the system, the service provider may still allow subscribers to view and manage their accounts using traditional means. For example, service providers typically allow access to account information over the Internet 185 on a web site hosted by a web server 180. The web server 180 is coupled to the billing maintenance system 110 to perform monitoring and topping up as requested by subscribers using their personal computers 190.

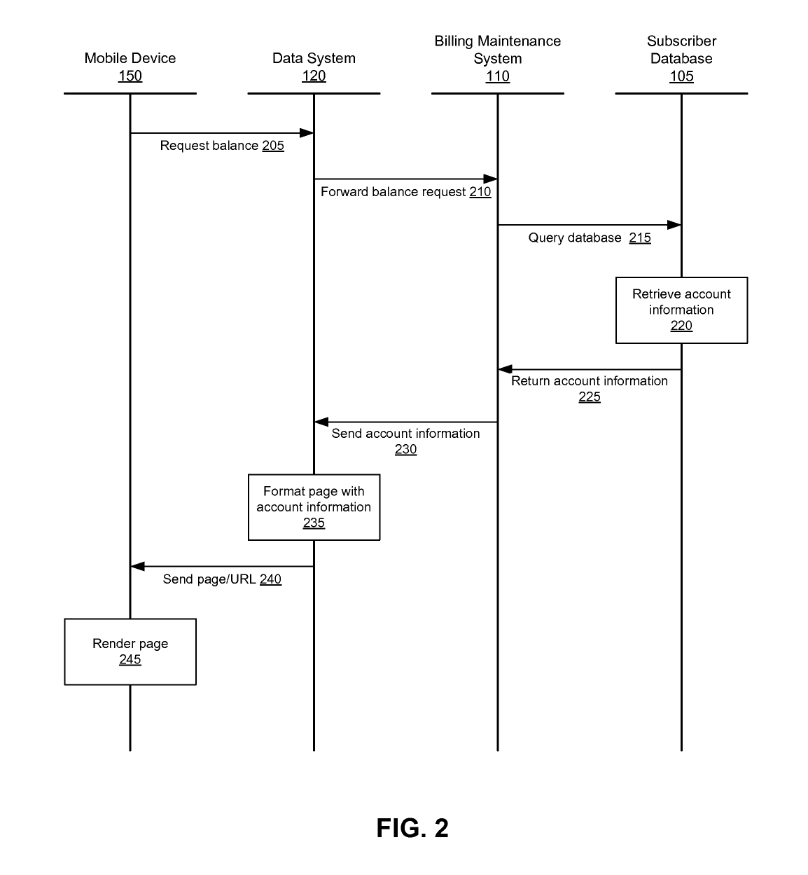

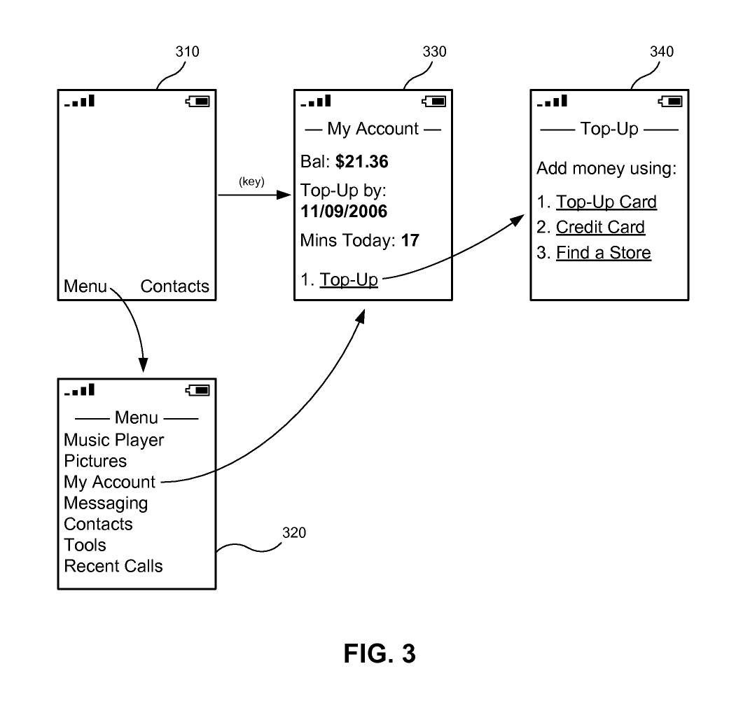

FIG. 2 shows the communications among the mobile device 150, the data system 120, the billing maintenance system 110, and the subscriber database 105 for one embodiment of a process for providing balance information to a subscriber. Consistent with the process shown in FIG. 2, FIG. 3 depicts an example user interface on a mobile device 150, illustrating screens that may be presented to a subscriber while requesting and receiving balance information. In systems that vary from that shown in FIG. 1 and described above, the process for providing balance information to subscribers may vary accordingly.

As shown in FIG. 2, a subscriber begins the process by requesting balance information from the subscriber's mobile device 150. The balance information may be requested in many ways, depending on the user interface. For example, the subscriber may navigate from a base screen 310 on the mobile device 150 to a menu 320. As FIG. 3 illustrates, the menu screen 320 contains a selection from which the subscriber may navigate to the subscriber's account information, including the account balance. In another embodiment, the mobile device 150 may include a special key for selecting the account information from at least one or more of the screens of the device's user interface. For example, the mobile devices 150 typically include arrow buttons for navigating their interface, but from a main screen 310 these arrow buttons double as hotkeys for selecting features of the device (such as a contacts list, a camera, and other features). Accordingly, a subscriber may make a selection for the account information directly from a main screen 310, and/or from other commonly used screens, using a single keystroke from the mobile phone 150. This ease of operation encourages use of the balance checking feature.

In the embodiment of FIG. 2, responsive to the subscriber selection, the mobile device 150 sends 205 a request for the balance information associated with the subscriber's account. Alternatively, the subscriber may request balance information for another account but would have to include authenticating information to ensure privacy. The balance request may be made through the data system, using, for example, the WAP protocol. In the balance request, the data system 120 further includes a unique identifier for the requesting subscriber, such as a phone number associated with the subscriber's account. The data system 120 forwards 210 the balance request to the billing maintenance system 110. If the data system 120 and billing maintenance system 110 are coupled over a network, such as a LAN or WAN, the may communicate using standard protocols like TCP/IP.

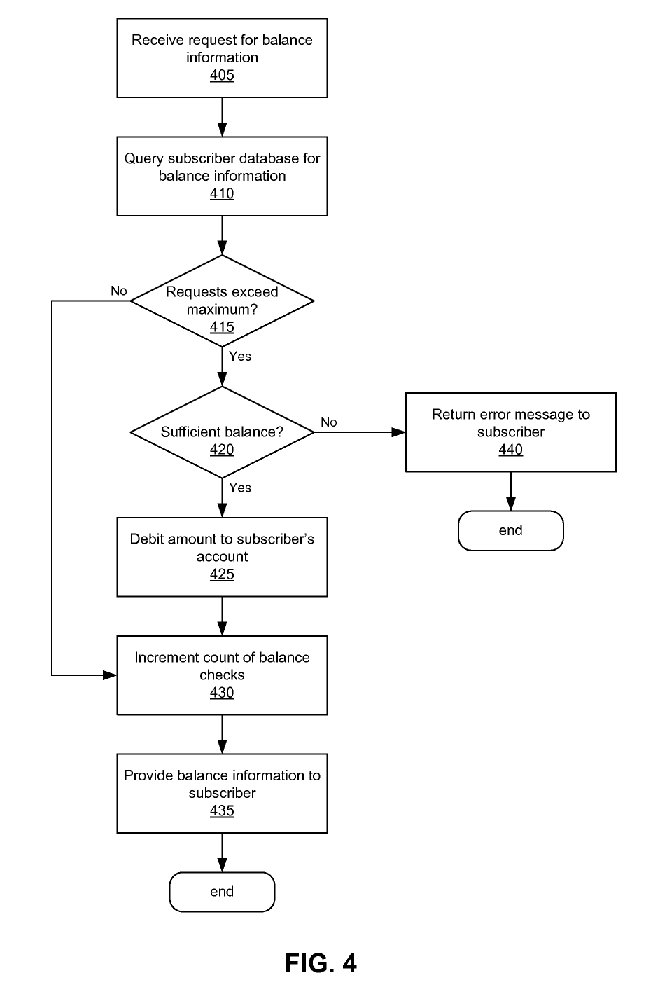

Responsive to the request, the billing maintenance system 110 queries 215 the subscriber database 105 with the subscriber's unique identifier. The subscriber database 105 retrieves 220 the subscriber's account information, which may include the minutes used, an account expiration date, and other information as well as the account balance. The subscriber database 105 returns 225 this information to the billing maintenance system 110. In the embodiment shown in FIG. 2, the billing maintenance system 110 automatically responds to the subscriber's balance request; however, the billing maintenance system 110 may service the request conditionally and possibly charge for the service based on any number of predefined criteria. An embodiment of such a process is shown in FIG. 4 and described in more detail below.

When the billing maintenance system 110 has the requested balance information, the billing maintenance system 110 sends 230 that information to the data system 120. The data system 120 then formats 235 a page of information with the balance information, and possibly additional information retrieved about the subscriber's account. In one embodiment, the information is formatted on the page in a markup language, including but not limited to Wireless Markup Language (WML), Compact Wireless Markup Language (CWML), Hypertext Markup Language (HTML), and Compact Hypertext Markup Language (cHTML). The format selected will depend in part on the capabilities of the wireless device 150 and the network. Once the page is formatted, the data system 120 sends 240 the page, or a link thereto, to the mobile device. The device then renders 245 the account information page on the device's display, as shown in screen 330.

In the example account information screen 330 shown in FIG. 3, the subscriber is presented with the account balance as well as additional information about the account. The user interface also presents the subscriber with a link to add value to the account, or “top up” the account. Providing the link on the account information screen 330 encourages the addition of value to the account because it presents the option while the subscriber is presented with the account balance information, which may indicate that the account needs to have valued added to it. Accordingly, the subscriber may selects the top up function from the account information screen 330, and the subscriber is then immediately presented with a payment screen 340 for purchasing more services from the service provider.

FIG. 4 illustrates a process in the billing maintenance system 110 for conditionally servicing a request for balance information and charging for certain requests. The process described implements a particular set of business rules; however, any other set of rules or criteria can be implemented by programming the billing maintenance system 110 accordingly. As described with reference to FIG. 2, when the billing maintenance system 110 receives 305 a request for the balance information of a particular account, it queries 310 the subscriber database 105 for the requested information. In the process shown in FIG. 4, however, the billing maintenance system 110 does not automatically return the balance information to the subscriber. Instead, it allows for a predetermined number of free balance checks during a particular time period (e.g., two free checks per day). After the subscriber exceeds the maximum free number of balance checks, the billing maintenance system 110 begins to charge the subscriber for additional checks as long as the subscriber has sufficient funds, and denies the requests if the subscriber does not.

According to the flow diagram, the system determines 315 if the maximum number of free balance checks has been exceeded. The number of balance checks can be tracked by a counter associated with the subscriber's account and maintained in the subscriber database 105 or in the billing maintenance system 110. If the number has not been exceeded, the system increments 330 the count and provides 335 the balance information to the subscriber. If the number has been exceeded, the system then determines 320 whether the account has a sufficient amount to cover the cost of checking the balance. If the account does not, the system returns 340 an error message to the subscriber, informing the subscriber that the account has insufficient funds and encouraging the subscriber to add value to the account. If the account does have sufficient value, the billing maintenance system 110 debits 325 the account a predefined cost for checking (typically a small amount, e.g., $0.02), and then the system increments 330 the count and provides 335 the balance information to the subscriber as described above.

Although the systems and methods described above are in the context of a pre-paid wireless service, other embodiments of the invention may be applied to traditional monthly accounts. In such embodiments, the balance information provided to a subscriber is not the remaining value in the subscriber's pre-paid account, but rather an amount of fees incurred by the subscriber to that point in time. For example, a subscriber may wish to access the subscriber's current account balance to determine a current liability. Any of the other features of embodiments described above may be implemented in this context, including the feature of charging a subscriber for checking the account balance under certain conditions. Accordingly, the invention need not be limited to pre-paid wireless services.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

What is claimed is:

1. A method for providing real-time balance information to a subscriber of a wireless communication service, the method comprising:
receiving from a mobile wireless device a request for balance information for an account associated with the mobile device;
querying a subscriber database to obtain the balance information for the account associated with the mobile device; and
directing the mobile wireless device to a page containing the requested balance information, the page viewable by the mobile wireless device.

2. The method of claim 1, wherein the mobile wireless device is a cellular phone.

3. The method of claim 1, wherein the request for balance information is received from the mobile wireless device using the Wireless Application Protocol (WAP).

4. The method of claim 1, wherein the page contains the requested balance information encoded in Wireless Markup Language (WML).

5. The method of claim 1, wherein the account is a pre-paid account, and the balance information reflects a remaining value in the account.

6. The method of claim 5, wherein the page further contains a daily total of minutes used for the account.

7. The method of claim 5, wherein the page further contains a deadline to add value to the account to keep the account active.

8. The method of claim 5, wherein the page further contains a link for adding value to the account.

9. The method of claim 1, further comprising:
debiting an amount of value from the account in exchange for providing the balance information to the mobile wireless device.

10. The method of claim 1, further comprising:
debiting an amount of value from the account if the balance information has been provided to the mobile wireless device more than a predetermined maximum number of free balance checks.

11. A method for obtaining real-time balance information from a mobile wireless device, the method comprising:
receiving a user selection for balance information for an account associated with the mobile wireless device;
transmitting a request for balance information to a wireless service provider in response to the user selection;
receiving a page containing the requested balance information; and
rendering the page in a display of the mobile wireless device to display the balance information.

12. The method of claim 11, wherein the mobile wireless device is a cellular phone.

13. The method of claim 11, wherein the request is transmitted according to the Wireless Application Protocol (WAP).

14. The method of claim 11, wherein the page contains the requested balance information encoded in Wireless Markup Language (WML).

15. The method of claim 10, wherein receiving the page comprises:
receiving a URL from the service provider; and
using the URL to access a Wireless Application Protocol (WAP) page from a WAP server.

16. The method of claim 11, wherein the account is a pre-paid account and the balance information reflects a remaining value in the account.

17. The method of claim 16, wherein the page further contains a link for adding value to the account.

18. The method of claim 11, wherein the user selection is input using a single keystroke from a top-level screen of a user interface of the mobile wireless device.

19. The method of claim 11, wherein the request for balance information includes a unique identifier for the mobile wireless device.

20. The method of claim 19, wherein the unique identifier comprises a phone number for the mobile wireless device.

21. A method for providing real-time balance information to a subscriber of a wireless communication service, the method comprising:
receiving a request for balance information of a subscriber's account from a wireless device, the request received via a Wireless Application Protocol (WAP) server;
obtaining a count of previous balance checks for the account during a predetermined time period;
obtaining the balance of the account from a subscriber database;
determining whether a predetermined maximum number of balance checks have been made;
if a predetermined maximum number of balance checks have been made, determining whether a minimum debit amount exists in the account;
providing the balance to the wireless device if a predetermined maximum number of balance checks have not been made;
providing the balance to the wireless device and debiting the account the debit amount if the predetermined maximum number of balance checks have been made and a minimum debit amount exists in the account; and
providing an error message to the wireless device if the predetermined maximum number of balance checks have been made and a minimum debit amount does not exist in the account.

21. The method of claim 20, wherein the balance or error message provided to the wireless device comprises a WAP page provided via a WAP server.

22. The method of claim 20, further comprising:
incrementing the count if the balance was provided to the wireless device.

23. The network of claim 20, wherein the account is a pre-paid account, and the balance information in the account reflects a remaining value in the account

24. A method for providing real-time balance information to subscribers of a wireless communication service, the method comprising:
receiving requests for balance information over a wireless communications network, each request identifying an account of a subscriber;
responsive to the requests for balance information, querying a subscriber database for balance information of the accounts associated with the requests; and
a step for servicing the requests for balance information, the servicing of each account based at least in part on (1) a number of previous requests made for the account during a predetermined time period and (2) whether a predetermined amount of value remains in the account.

25. The method of claim 24, further comprising:
a step for charging the accounts for the requests for balance information.

26. A wireless services network allowing subscribers of the network to obtain real-time balance information for their accounts, the network comprising:
a wireless communications network for communicating with a plurality of wireless devices to allow usage of the wireless services network by the subscribers;
a data system for providing data services to wireless devices over the wireless communications network;
a subscriber database that stores account information for subscribers of the network, the account information comprising balance information for each subscriber's account; and
a billing maintenance system configured to update the subscribers' account information based on the subscribers' usage of services over the wireless communications network, the billing maintenance system further configured to receive requests from the subscribers for account balance information and to provide pages containing the requested balance information and viewable by the mobile wireless devices to the subscribers over the data system responsive to the requests.

27. The network of claim 26, wherein the billing maintenance system is configured to receive the requests for balance information using the Wireless Application Protocol (WAP)

28. The network of claim 26, wherein the data system comprises a Wireless Application Protocol (WAP) server, and the pages contain the requested balance information encoded in Wireless Markup Language (WML).

29. The network of claim 26, wherein the accounts are pre-paid accounts, and the balance information in each account reflects a remaining value in the account

30. The network of claim 29, wherein the pages further contain a daily total of minutes used for the account.

31. The network of claim 29, wherein the pages further contain a deadline to add value to the account to keep the account active.

32. The network of claim 29, wherein the pages further contain a link for adding value to the account.

33. The network of claim 26, wherein the billing maintenance system is further configured to debit an amount of value from the accounts in exchange for providing the balance information.

34. The network of claim 26, wherein the billing maintenance system is further configured to debit an amount of value from the accounts in exchange for providing the balance information if the balance information has been provided more than a predetermined maximum number of free balance checks.

35. The network of claim 26, wherein the billing maintenance system is further configured to debit an amount of value from the accounts in exchange for providing the balance information and to disallow balance checking for account having a value below the debited amount.
